(19) United States
(12) Patent Application Publication
(10) Pub. No.: US 2024/0077874 A1
(43) Pub. Date: Mar. 7, 2024

(54) MOVING OBJECT CONTROL SYSTEM, CONTROL METHOD THEREOF, STORAGE MEDIUM, AND MOVING OBJECT

(71) Applicant: HONDA MOTOR CO., LTD., Tokyo (JP)

(72) Inventors: Koki AIZAWA, Wako-shi (JP); Yunosuke KURAMITSU, Wako-shi (JP); Ryoji WAKAYAMA, Wako-shi (JP); Hideki MATSUNAGA, Wako-shi (JP)

(21) Appl. No.: 18/240,393

(22) Filed: Aug. 31, 2023

(30) Foreign Application Priority Data
Sep. 6, 2022 (JP) 2022-141498

(51) Int. Cl. G05D 1/02

(52) U.S. Cl. CPC G05D 1/0217; G05D 1/0246; G05D 2201/0212

(57) ABSTRACT

The present invention directs to a moving object control system comprising acquiring a captured image; detecting an obstacle included in the captured image; dividing a region around a moving object and generate an occupancy map indicating occupancy of the obstacle detected for each of divided regions; and generating a global path from a current position to a target position for avoiding the detected obstacle based on a first cost, a second cost, and a third cost, the first cost being higher as a distance from the current position is longer on the occupancy map, the second cost being higher as a distance from the target position is longer on the occupancy map, and the third cost being higher as a distance from a past path is longer on the occupancy map.

### CROSS-REFERENCE TO RELATED APPLICATION(S)

This application claims priority to and the benefit of Japanese Patent Application No. 2022-141498 filed on Sep. 6, 2022, the entire disclosure of which is incorporated herein by reference.

### BACKGROUND OF THE INVENTION

### Field of the Invention

The present invention relates to a moving object control system, a control method thereof, a storage medium, and a moving object.

### Description of the Related Art

In recent years, compact moving objects are known such as electric vehicles called ultra-compact mobility vehicles (also referred to as micro mobility vehicles) having a riding capacity of about one or two persons, and mobile robots that provide various types of services to humans. Some of such moving objects autonomously travel while periodically generating a travel path to a destination.

Japanese Patent Laid-Open No. 2019-128962 discloses that a first trajectory is generated based on a map and route information, a path and a speed of the first trajectory are optimized based on obstacle information and the like, and a second trajectory for controlling an automated vehicle is generated based on the optimized path and speed.

### SUMMARY OF THE INVENTION

In the above-described related art, path planning is performed based on highly precise map information provided from a server. However, a small moving object has insufficient hardware resources, and it is difficult to secure an area for storing such highly precise map information and a communication device for acquiring a large amount of the map information at high speed. Further, there is a possibility that a highly precise map is not prepared in a region where the small moving object travels, and thus, it is necessary to generate a path without using such map information.

On the other hand, it has been known to use a cost function based on distances to destinations or distances to obstacles in order to optimize a path. In such a cost function, the path avoiding the obstacles can be generated, but there is a problem that a search range is wide so that a processing amount increases. It is extremely important to reduce a processing load when a path is periodically generated in real time in the small moving object having insufficient hardware resources.

The present invention has been made in view of the above problems, and an object thereof is to suitably generate a path of a moving object without using a high-precision map.

According to one aspect the present invention, there is provided a moving object control system comprising: an acquisition unit configured to acquire a captured image; a detection unit configured to detect an obstacle included in the captured image; a map generation unit configured to divide a region around a moving object and generate an occupancy map indicating occupancy of the obstacle detected by the detection unit for each of divided regions; and a path generation unit configured to generate a global path from a current position to a target position for avoiding the detected obstacle based on a first cost, a second cost, and a third cost, the first cost being higher as a distance from the current position is longer on the occupancy map, the second cost being higher as a distance from the target position is longer on the occupancy map, and the third cost being higher as a distance from a past path is longer on the occupancy map.

According to another aspect the present invention, there is provided a moving object comprising: an acquisition unit configured to acquire a captured image; a detection unit configured to detect an obstacle included in the captured image; a map generation unit configured to divide a region around the moving object and generate an occupancy map indicating occupancy of the obstacle detected by the detection unit for each of divided regions; and a path generation unit configured to generate a global path from a current position to a target position for avoiding the detected obstacle based on a first cost, a second cost, and a third cost, the first cost being higher as a distance from the current position is longer on the occupancy map, the second cost being higher as a distance from the target position is longer on the occupancy map, and the third cost being higher as a distance from a past path is longer on the occupancy map.

According to yet another aspect the present invention, there is provided a control method of a moving object control system, the control method comprising: acquiring a captured image; detecting an obstacle included in the captured image; dividing a region around a moving object and generating an occupancy map indicating occupancy of the obstacle detected for each of divided regions; and generating a global path from a current position to a target position for avoiding the detected obstacle based on a first cost, a second cost, and a third cost, the first cost being higher as a distance from the current position is longer on the occupancy map, the second cost being higher as a distance from the target position is longer on the occupancy map, and the third cost being higher as a distance from a past path is longer on the occupancy map.

According to still yet another aspect the present invention, there is provided a non-transitory storage medium storing a program that causes a computer to function as: an acquisition unit configured to acquire a captured image; a detection unit configured to detect an obstacle included in the captured image; a map generation unit configured to divide a region around a moving object and generate an occupancy map indicating occupancy of the obstacle detected by the detection unit for each of divided regions; and a path generation unit configured to generate a global path from a current position to a target position for avoiding the detected obstacle based on a first cost, a second cost, and a third cost, the first cost being higher as a distance from the current position is longer on the occupancy map, the second cost being higher as a distance from the target position is longer on the occupancy map, and the third cost being higher as a distance from a past path is longer on the occupancy map.

Further features of the present invention will become apparent from the following description of exemplary embodiments (with reference to the attached drawings).

### BRIEF DESCRIPTION OF THE DRAWINGS

FIGS. 1A and 1B are block diagrams illustrating a hardware configuration example of a moving object according to the present embodiment;

FIG. 2 is a block diagram illustrating a control configuration of the moving object according to the present embodiment;

FIG. 3 is a block diagram illustrating functional configurations of the moving object according to the present embodiment;

FIG. 4 is a view illustrating an occupancy grid map according to the present embodiment;

FIG. 5 is a view illustrating a method for generating the occupancy grid map according to the present embodiment;

FIG. 6 is a view illustrating a global path and a local path according to the present embodiment;

FIG. 7 is a view illustrating a method of generating the global path according to the present embodiment;

FIG. 8 is a view illustrating a method of optimizing a global path according to the present embodiment;

FIG. 9 is a flowchart illustrating a processing procedure for controlling traveling of the moving object according to the present embodiment; and

FIG. 10 is a flowchart illustrating a detailed processing procedure for generating a path according to the present embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

<Configuration of Moving Object>

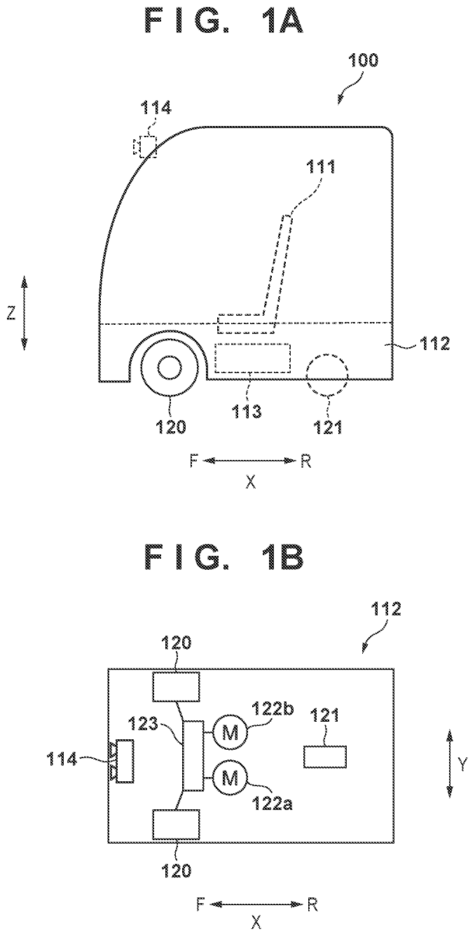

A configuration of a moving object 100 according to the present embodiment will be described with reference to FIGS. 1A and 1B. FIG. 1A illustrates a side surface of the moving object 100 according to the present embodiment, and FIG. 1B illustrates an internal configuration of the moving object 100. In the drawings, an arrow X indicates a front-and-rear direction of the moving object 100, F indicates the front, and R indicates the rear. Arrows Y and Z respectively indicate a width direction (a left-and-right direction) and an up-and-down direction of the moving object 100.

The moving object 100 is equipped with a battery 113, and is, for example, an ultra-compact mobility vehicle that moves mainly by the power of a motor. The ultra-compact mobility vehicle is an ultra-compact vehicle that is more compact than a general automobile and has a riding capacity of about one or two persons. In the present embodiment, an ultra-compact mobility vehicle with three wheels will be described as an example of the moving object 100, but there is no intention to limit the present invention, and for example, a four-wheeled vehicle or a straddle type vehicle may be used. Further, the vehicle of the present invention is not limited to a vehicle that carries a person, and may be a vehicle loaded with luggage and traveling alongside a person who is walking, or a vehicle leading a person. Furthermore, the present invention is not limited to a four-wheeled or two-wheeled vehicle, and a walking type robot or the like capable of autonomous movement can also be applied.

The moving object 100 is an electric autonomous vehicle including a traveling unit 112 and using a battery 113 as a main power supply. The battery 113 is, for example, a secondary battery such as a lithium ion battery, and the moving object 100 autonomously travels by the traveling unit 112 by electric power supplied from the battery 113. The traveling unit 112 is a three-wheeled vehicle including a pair of left and right front wheels 120 and a tail wheel (driven wheel) 121. The traveling unit 112 may be in another form, such as a four-wheeled vehicle. The moving object 100 includes a seat 111 for one person or two persons.

The traveling unit 112 includes a steering mechanism 123. The steering mechanism 123 uses motors 122a and 122b as a drive source to change a steering angle of the pair of front wheels 120. An advancing direction of the moving object 100 can be changed by changing the steering angle of the pair of front wheels 120. The tail wheel 121 is a driven wheel that does not individually have a drive source but operates following driving of the pair of front wheels 120. Further, the tail wheel 121 is connected to a vehicle body of the moving object 100 with a turning portion. The turning portion rotates such that an orientation of the tail wheel 121 changes separately from the rotation of the tail wheel 121. In this manner, the moving object 100 according to the present embodiment adopts a differential two-wheel mobility vehicle with the tail wheel, but is not limited thereto.

The moving object 100 includes a detection unit 114 that recognizes a plane in front of the moving object 100. The detection unit 114 is an external sensor that monitors the front of the moving object 100, and is an imaging apparatus that captures an image of the front of the moving object 100 in the case of the present embodiment. In the present embodiment, a stereo camera having an optical system such as two lenses and respective image sensors will be described as an example of the detection unit 114. However, instead of or in addition to the imaging apparatus, a radar or a light detection and ranging (LIDAR) can also be used. Further, an example in which the detection unit 114 is provided only in front of the moving object 100 will be described in the present embodiment, but there is no intention to limit the present invention, and the detection unit 114 may be provided at the rear, the left, or right of the moving object 100.

The moving object 100 according to the present embodiment captures an image of a front region of the moving object 100 using the detection unit 114, and detects an obstacle from the captured image. Furthermore, the moving object 100 divides a peripheral region of the moving object 100 into grids, and controls traveling while generating an occupancy grid map in which obstacle information is accumulated in each of the grids. Details of the occupancy grid map will be described later.

<Control Configuration of Moving Object>

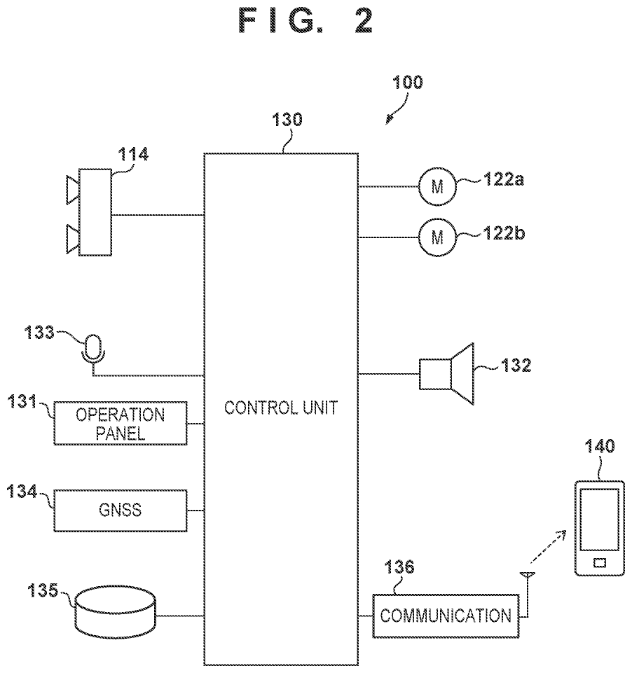

FIG. 2 is a block diagram of a control system of the moving object 100 according to the present embodiment. Here, a configuration necessary for carrying out the present invention will be mainly described. Therefore, other configurations may be further included in addition to the configuration described below. Further, a description is given in the present embodiment assuming that each unit to be described below is included in the moving object 100, but there is no intention to limit the present invention, and a moving object control system including a plurality of devices may be achieved. For example, some functions of a control unit 130 may be achieved by a server apparatus connected to be capable of communicating with each other, or the detection unit 114 or a GNSS sensor 134 may be provided as an external device. The moving object 100 includes the control unit (ECU) 130. The control unit 130 includes a processor represented by a CPU, a storage device such as a semiconductor memory, an interface with an external device, and the like. The storage device stores a program executed by the processor, data used for processing by the processor, and the like. A plurality of sets of the processor, the storage device, and the interface may be provided for an each function of the moving object 100 to be capable of communicating with each other.

The control unit 130 acquires a detection result of the detection unit 114, input information of an operation panel 131, voice information input from a voice input apparatus 133, position information from the GNSS sensor 134, and reception information via a communication unit 136, and executes corresponding processing. The control unit 130 performs control of the motors 122a and 122b (traveling control of the traveling unit 112), display control of the operation panel 131, notification to an occupant of the moving object 100 by voice of a speaker 132, and output of information.

The voice input apparatus 133 can collect a voice of the occupant of the moving object 100. The control unit 130 can recognize the input voice and execute processing corresponding to the recognized input voice. The global navigation satellite system (GNSS) sensor 134 receives a GNSS signal, and detects a current position of the moving object 100. A storage apparatus 135 is a storage device that stores a captured image by the detection unit 114, obstacle information, a path generated in the past, an occupancy grid map, and the like. The storage apparatus 135 may also store a program to be executed by the processor, data for use in processing by the processor, and the like. The storage apparatus 135 may store various parameters (for example, learned parameters of a deep neural network, hyperparameters, and the like) of a machine learning model for voice recognition or image recognition executed by the control unit 130.

The communication unit 136 communicates with a communication apparatus 140, which is an external apparatus, via wireless communication such as Wi-Fi or 5th generation mobile communication. The communication apparatus 140 is, for example, a smartphone, but is not limited thereto, and may be an earphone type communication terminal, a personal computer, a tablet terminal, a game machine, or the like. The communication apparatus 140 is connected to a network via wireless communication such as Wi-Fi or 5th generation mobile communication.

A user who owns the communication apparatus 140 can give an instruction to the moving object 100 via the communication apparatus 140. The instruction includes, for example, an instruction for calling the moving object 100 to a position desired by the user for joining. When receiving the instruction, the moving object 100 sets a target position based on position information included in the instruction. Note that, in addition to such an instruction, the moving object 100 can set the target position from the captured image of the detection unit 114, or can set the target position based on an instruction, received via the operation panel 131, from the user riding on the moving object 100. In the case of setting the target position from the captured image, for example, a person raising a hand toward the moving object 100 in the captured image is detected, and a position of the detected person is estimated and set as the target position.

<Functional Configurations of Moving Object>

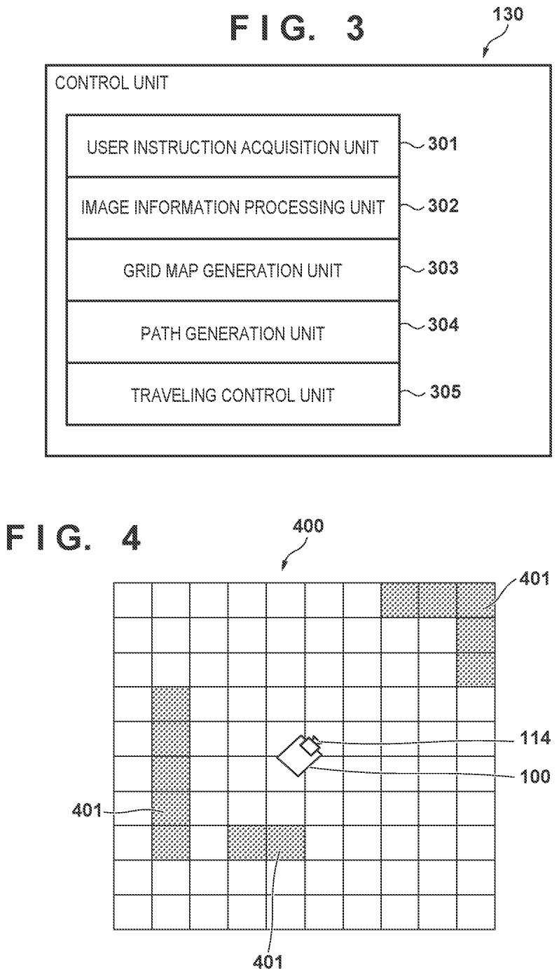

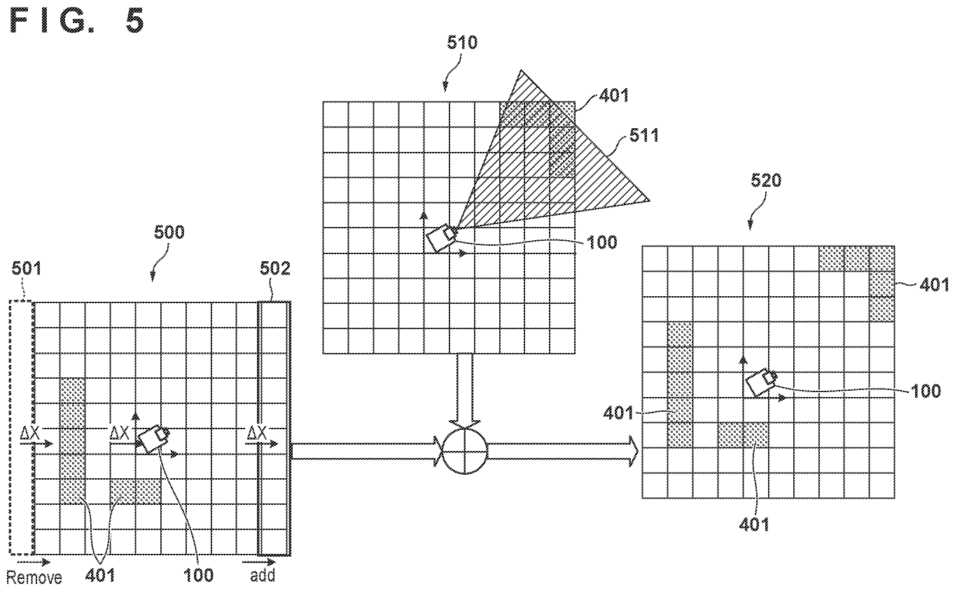

Next, functional configurations of the moving object 100 according to the present embodiment will be described with reference to FIG. 3. The functional configurations described here are achieved as, for example, the CPU in the control unit 130 reads a program stored in a memory such as a ROM into a RAM and executes the program. Note that the functional configurations described below describe only functions necessary for describing the present invention, and do not describe all of functional configurations actually included in the moving object 100. That is, the functional configurations of the moving object 100 according to the present invention are not limited to the functional configurations described below.

A user instruction acquisition unit 301 has a function of receiving an instruction from a user, and can receive a user instruction via the operation panel 131, a user instruction from an external apparatus such as the communication apparatus 140 via the communication unit 136, and an instruction by an utterance of the user via the voice input apparatus 133. As described above, the user instructions include an instruction for setting the target position (also referred to as a destination) of the moving object 100 and an instruction related to traveling control of the moving object 100.

An image information processing unit 302 processes the captured image acquired by the detection unit 114. Specifically, the image information processing unit 302 creates a depth image from a stereo image acquired by the detection unit 114 to obtain a three-dimensional point cloud. Image data converted into the three-dimensional point cloud is used to detect an obstacle that hinders traveling of the moving object 100. The image information processing unit 302 may include a machine learning model that processes image information and execute processing of a learning stage or processing of an inference stage of the machine learning model. The machine learning model of the image information processing unit 302 can perform processing of recognizing a three-dimensional object and the like included in the image information by performing computation of a deep learning algorithm using a deep neural network (DNN), for example.

A grid map generation unit 303 creates a grid map of a predetermined size (for example, in a region of 20 m×20 m with each cell of 10 cm×10 cm) based on the image data of the three-dimensional point cloud. This is intended to reduce the amount since the amount of data of the three-dimensional point cloud is large and real-time processing is difficult. The grid map includes, for example, a grid map indicating a difference between a maximum height and a minimum height of an intra-grid point cloud (representing whether or not the cell is a step) and a grid map indicating a maximum height of the intra-grid point cloud from a reference point (representing a topography shape of the cell). Furthermore, the grid map generation unit 303 removes spike noise and white noise included in the generated grid map, detects an obstacle having a predetermined height or more, and generates an occupancy grid map indicating whether or not there is a three-dimensional object as the obstacle for each grid.

A path generation unit 304 generates a travel path of the moving object 100 with respect to the target position set by the user instruction acquisition unit 301. Specifically, the path generation unit 304 generates the path using the occupancy grid map generated by the grid map generation unit 303 from the captured image of the detection unit 114 without requiring obstacle information of a high-precision map. Note that the detection unit 114 is the stereo camera that captures the image of the front region of the moving object 100, and thus, is not able to recognize obstacles in the other directions. Therefore, it is desirable that the moving object 100 stores detected obstacle information for a predetermined period in order to avoid a collision with an obstacle outside a viewing angle and a stack in a dead end. As a result, the moving object 100 can generate the path in consideration of both an obstacle detected in the past and an obstacle detected in real time.

Further, the path generation unit 304 periodically generates a global path using the occupancy grid map, and further periodically generates a local path so as to follow the global path. That is, a target position of the local path is determined by the global path. In the present embodiment, as a generation cycle of each path, the generation cycle of the global path is set to 100 ms, and the generation cycle of the local path is set to 50 ms, but the present invention is not limited thereto. As an algorithm for generating a global path, various algorithms such as a rapid-exploring random tree (RRT), a probabilistic road map (PRM), and A* are known. The path generation unit 304 according to the present embodiment is based on the A* algorithm in consideration of compatibility and reproducibility in a case where the cell of the grid is treated as a node, and uses a method obtained by improving the algorithm in order to further reduce a calculation amount. Details of the method will be described later. Further, since the differential two-wheel mobility with the tail wheel is adopted as the moving object 100, the path generation unit 304 generates the local path in consideration of the tail wheel 121 which is the driven wheel.

The traveling control unit 305 controls the traveling of the moving object 100 in accordance with the local path. Specifically, the traveling control unit 305 controls the traveling unit 112 in accordance with the local path to control a speed and an angular velocity of the moving object 100. Further, the traveling control unit 305 controls traveling in response to various operations of a driver. When a deviation occurs in a driving plan of the local path due to an operation of the driver, the traveling control unit 305 may control traveling by acquiring a new local path generated by the path generation unit 304 again, or may control the speed and angular velocity of the moving object 100 so as to eliminate the deviation from the local path in use.

<Occupancy Grid Map>

FIG. 4 illustrates an occupancy grid map 400 including obstacle information according to the present embodiment. Since the moving object 100 according to the present embodiment travels without depending on obstacle information of a high-precision map, the obstacle information is entirely acquired from a recognition result of the detection unit 114. At this time, it is necessary to store the obstacle information in order to avoid a collision with an obstacle outside a viewing angle or a stack in a dead end. Therefore, in the present embodiment, an occupancy grid map is used as a method of storing the obstacle information from the viewpoint of reduction in the amount of information of a three-dimensional point cloud of a stereo image and ease of handling in path planning.

The grid map generation unit 303 according to the present embodiment divides a peripheral region of the moving object 100 into grids, and generates an occupancy grid map including information indicating the presence or absence of an obstacle for each of the grids. Note that an example in which a predetermined region is divided into grids will be described here. However, instead of being divided into grids, the predetermined region may be divided into other shapes to create an occupancy map indicating the presence or absence of an obstacle for each divided region. In the occupancy grid map 400, a region having a size of, for example, 40 m×40 m or 20 m×20 m around the moving object 100 is set as the peripheral region, the region is divided into grids of 20 cm×20 cm or 10 cm×10 cm, and is dynamically set in accordance with movement of the moving object 100. That is, the occupancy grid map 400 is a region that is shifted such that the moving object 100 is always at the center in accordance with the movement of the moving object 100 and varies in real time. Note that any size of the region can be set based on hardware resources of the moving object 100.

Further, in the occupancy grid map 400, presence/absence information of an obstacle detected from the captured image by the detection unit 114 is defined for each grid. As the presence/absence information, for example, a travelable region is defined as “0”, and a non-travelable region (that is, presence of an obstacle) is defined as “1”. In FIG. 4, reference numeral 401 denotes a grid in which an obstacle is present. A region where an obstacle is present indicates a region through which the moving object 100 is not able to pass, and includes, for example, a three-dimensional object of 5 cm or more. Therefore, the moving object 100 generates a path so as to avoid these obstacles 401.

<Accumulation of Obstacle Information>

FIG. 5 illustrates accumulation of obstacle information in an occupancy grid map according to the present embodiment. Reference numeral 500 denotes a local map that moves in accordance with movement of the moving object 100. The local map 500 is shifted in accordance with the movement of the moving object 100 with respect to an x-axis direction and a y-axis direction on the grid map. The local map 500 illustrates a state in which a dotted line region of 501 is removed and a solid line region of 502 is added according to a movement amount Δx of the moving object 100 in the x-axis direction, for example. The region to be removed is a region opposite to an advancing direction of the moving object 100, and the region to be added is a region in the advancing direction. Similarly, regions are also removed and added in the y-axis direction in accordance with the movement of the moving object 100. Further, the local map 500 accumulates obstacle information detected in the past. When there is an obstacle in a grid included in the removed region, the obstacle information is removed from the local map 500, but is desirably held separately from the local map 500 for a certain period of time. Such information is effective, for example, in a case where the moving object 100 changes a course so that the removed region is included in the local map 500 again, and the avoidance accuracy of the moving object 100 with respect to the obstacle can be improved. Further, when the accumulated information is used, it is unnecessary to detect an obstacle again, and a processing load can be reduced.

Reference numeral 510 denotes an obstacle detection map indicating detection information of an obstacle present in front of the moving object 100 from the captured image captured by the detection unit 114 of the moving object 100. The obstacle detection map 510 indicates real-time information, and is periodically generated based on the captured image acquired from the detection unit 114. Note that, since moving obstacles such as a person and a vehicle are also assumed, it is desirable to update the obstacle detection map 510 generated periodically within a viewing angle 511 of the detection unit 114, which is a front region of the moving object 100, instead of fixing and accumulating obstacles detected in the past. As a result, the moving obstacles can also be recognized, and generation of a path with avoidance more than necessary can be prevented. On the other hand, the obstacles detected in the past are accumulated in a rear region (strictly speaking, outside the viewing angle of the detection unit 114) of the moving object 100 as illustrated in the local map 500. As a result, for example, when an obstacle is detected in the front region and a detour path is generated, it is possible to easily generate a path that avoids collisions with the passed obstacles.

Reference numeral 520 denotes an occupancy grid map generated by adding the local map 500 and the obstacle detection map 510. In this manner, the occupancy grid map 520 is generated as a grid map obtained by combining the local map and the obstacle detection information varying in real time with the obstacle information detected and accumulated in the past.

<Path Generation>

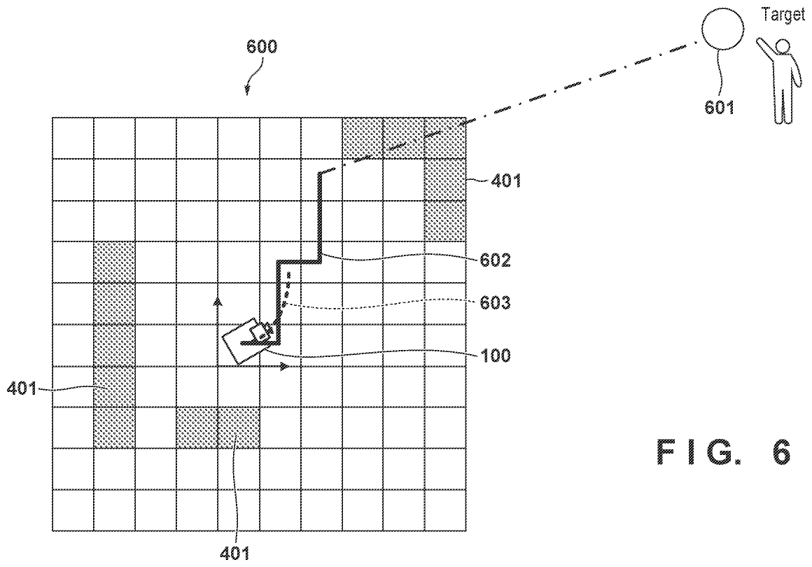

FIG. 6 illustrates a travel path generated in the moving object 100 according to the present embodiment. The path generation unit 304 according to the present embodiment periodically generates a global path 602 using an occupancy grid map in accordance with a set target position 601, and further periodically generates a local path 603 so as to follow the global path. A method of generating each of the global path and the local path will be described later.

The target position 601 is set based on various instructions. For example, an instruction from an occupant riding on the moving object 100 and an instruction from a user outside the moving object 100 are included. The instruction from the occupant is performed via the operation panel 131 or the voice input apparatus 133. The instruction via the operation panel 131 may be a method of designating a predetermined grid of a grid map displayed on the operation panel 131. In this case, a size of each grid may be set to be large, and the grid may be selectable from a wider range of the map. The instruction via the voice input apparatus 133 may be an instruction using a surrounding target as a mark. The target may include a pedestrian, a signboard, a sign, equipment installed outdoors such as a vending machine, building components such as a window and an entrance, a road, a vehicle, a two-wheeled vehicle, and the like included in the utterance information. When receiving the instruction via the voice input apparatus 133, the path generation unit 304 detects a designated target from the captured image acquired by detection unit 114 and sets the target as the target position.

A machine learning model is used for these voice recognition and image recognition. The machine learning model performs, for example, computation of a deep learning algorithm using a deep neural network (DNN) to recognize a place name, a landmark name such as a building, a store name, a target name, and the like included in the utterance information and the image information. The DNN for the voice recognition becomes a learned state by performing the processing of the learning stage, and can perform recognition processing (processing of the inference stage) for new utterance information by inputting the new utterance information to the learned DNN. Further, the DNN of the image recognition can recognize a pedestrian, a signboard, a sign, equipment installed outdoors such as a vending machine, building components such as a window and an entrance, a road, a vehicle, a two-wheeled vehicle, and the like included in the image.

Further, regarding the instruction from the user outside the moving object 100, it is also possible to notify the moving object 100 of the instruction via the owned communication apparatus 140 via the communication unit 136 or call the moving object 100 by an operation such as raising a hand toward the moving object 100 as illustrated in FIG. 6. The instruction using the communication apparatus 140 is performed by an operation input or a voice input similarly to the instruction from the occupant.

<Method of Generating Global Path>

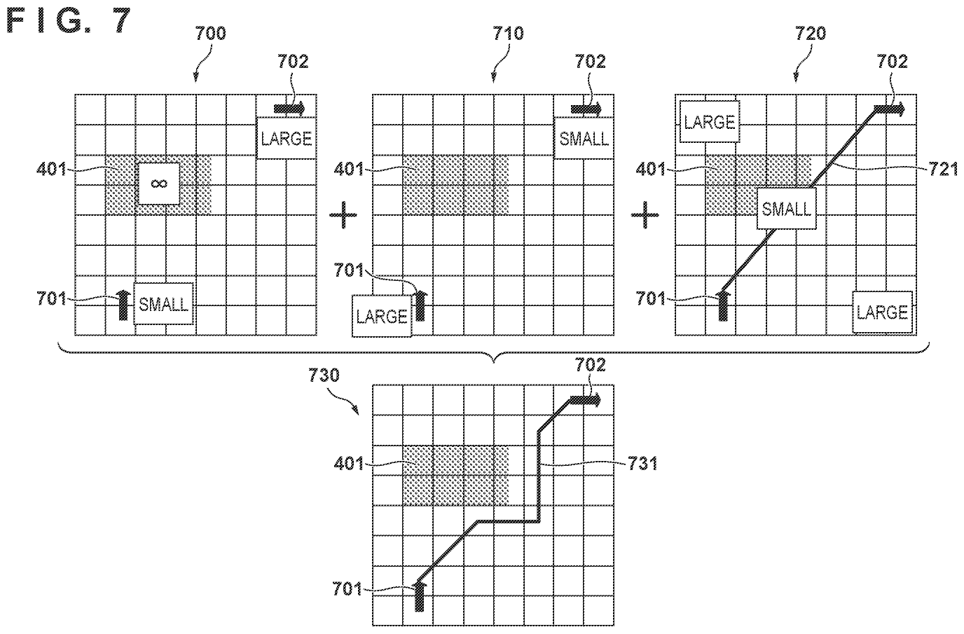

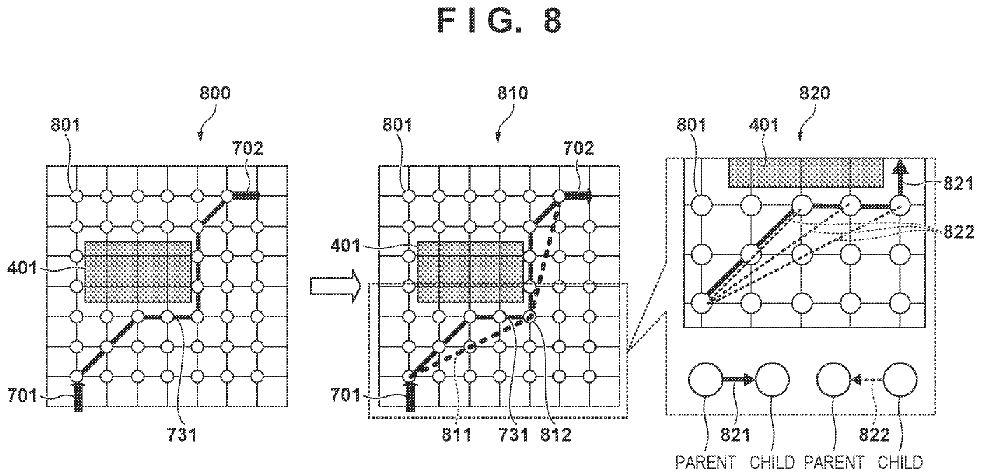

Hereinafter, a method of generating a global path according to the present embodiment will be described with reference to FIGS. 7 and 8. In the present embodiment, global path planning extends the A* algorithm with optimality and reproducibility under static conditions (improved A*). The improved A* is further optimized using Theta* to generate a grid-independent path.

(Improved A*)

FIG. 7 illustrates the improved A* algorithm according to the present embodiment. The A* algorithm treats a cell on a grid as a node and performs a full search every cycle, and thus, has an advantage of being capable of coping with a new obstacle and a change in a target position. On the other hand, A* has a large calculation amount as a negative effect of the full search in each cycle, and a path greatly changes due to the influence of some noise, which causes wobbling. In A*, an extension of a search node is determined by an actual movement cost and a heuristic function. As the heuristic function, an estimated distance to the target position is used. Here, the search node is further determined using path information (for example, previously generated path information) planned in the past according to the present embodiment. In this manner, the past path is considered as the improved A* to achieve reduction of a search area and suppression of a large-scale path change (wobbling) according to the present embodiment.

Reference numeral 700 denotes a cost map that defines, for each grid, a first cost that is higher as a distance from a current position of the moving object 100 is longer in a grid map. That is, the cost map 700 defines the movement cost of the moving object 100 for each grid, and is generated in each cycle. Reference numeral 701 denotes the current position of the moving object 100, which is a start position of a global path. Reference numeral 702 denotes an end position of the global path toward a target position of a generated path. The end position may be a final target position or a relay position halfway to the target position. Further, a square with “large” in the drawing indicates that the cost increases toward a corresponding position, and a square with “small” indicates that the cost decreases toward a corresponding position. “co” indicates that the cost of a grid in which an obstacle is present is made infinite. Therefore, the first cost considering the obstacle is defined in the cost map.

Reference numeral 710 denotes a heuristic map that defines, for each grid, a second cost that is higher as a distance from a target position is longer in the grid map. That is, the heuristic map 710 defines the estimated distance from the target position for each grid. Since an upper right direction is set as the target position in the heuristic map 710, the cost is defined to be lower toward the upper right, and the cost is defined to be higher toward the lower left.

Reference numeral 720 denotes a grid map used for determination of the search node, and indicates a past path map that defines, for each grid, a third cost that is higher as a distance from a past path is longer in the grid map. That is, the past path map 720 defines the presence or absence of the past path for each grid. Reference numeral 721 denotes the past path. In the present embodiment, the past path 721 indicates a global path generated previously. However, there is no intention to limit the present invention, and cumulative paths of past paths of past several times may be used. The past path map 720 is generated by setting a grid through which the past path has passed as “0” and a grid through which the past path has not passed as “1” and applying a Gaussian filter, an averaging filter, or the like to the grid map.

Using these grid maps, a search node i* of the improved A* according to the present embodiment can be determined by an evaluation function shown in the following Formula 1.

[Formula 1]

i*=argmin_{i∈OPEN}(Cᵢ+Hᵢ+kPᵢ) Formula (1)

Here, OPEN indicates a set of indexes of cells of grids included in OPENLIST of A*. Ci, Hi, and Pi indicate values of the first cost, the second cost, and the third cost, respectively. Further, k represents a coefficient. According to the above Formula 1, it is possible to preferentially search the vicinity of a region through which the past path 721 has passed in OPENLIST. In a case where it is difficult to find a path to the target position even if the region through which the past path 721 has passed is searched for, the path generation unit 304 widens a search range similarly to A* and continues the search until the path is found.

A grid map 730 illustrates a global path 731 generated by applying such an improved A* to avoid the obstacle. As described above, it is unnecessary to perform the entire search in consideration of the past path according to the improved A* applied in the present embodiment, and the search range can be greatly reduced. As shown in Formula 1, a matrix is added regarding the calculation of the evaluation function, and the calculation amount can be suppressed. Furthermore, since the cost of the grid in which the obstacle is present is set to “co”, there is an effect that it is difficult to generate a path passing through a final edge of the obstacle.

(Theta*)

FIG. 8 illustrates a method of optimizing the global path generated by the improved A*. A grid map 800 illustrates the global path 731 generated by the improved A*. Reference numeral 801 denotes a node corresponding to each grid. The path generated by the improved A* is a node-dependent path as illustrated in the global path 731, and is likely to be a path that does not proceed straight even between grids where there is no obstacle, and is not an optimal path in some cases. Therefore, the path is optimized by applying the Theta* algorithm to the above-described global path 731 generated by the improved A* according to the present embodiment.

A grid map 810 illustrates a global path 811 obtained by applying Theta* to optimize the global path 731. It can be seen that the global path 811 indicated by a dotted line is a more linear path as compared to the global path 731 generated by the improved A* and indicated by a solid line. For example, the global path 731 before optimization forms a trajectory along the obstacle 401 before and after the node 812, and a plurality of times of steering to the left and right are required as traveling control. On the other hand, the global path 811 after optimization forms a trajectory that is linear before and after the node 812, and is the shortest path with a small number of times of steering.

A grid map 820 illustrates a node search algorithm of the improved A* and Theta* in a dotted region in the grid map 810. In the improved A*, as indicated by a solid arrow 821, a node having the minimum distance is searched for in a direction from a parent node to a child node, that is, searched for in the forward direction to generate a trajectory. On the other hand, in the optimization using Theta*, as indicated by a dotted arrow 822, the global path 731 is optimized such that the distance from the child node to the parent node is minimized in the reverse direction. That is, an optimal parent node is searched for in Theta*. As a result, an optimal path that does not depend on the grid (node) can be generated. Further, the optimal parent node search is performed again based on the movement cost, and thus, it is possible to prevent excessive dependence on the past path.

<Method of Generating Local Path>

Next, a method of generating a local path will be described. The path generation unit 304 generates a local path so as to follow the generated global path. As a method of local path planning, there are various methods such as a dynamic window approach (DWA), model predictive control (MPC), clothoid tentacles, and proportional-integral-differential (PID) control. Although a case where the DWA is used will be described as an example in the present embodiment, there is no intention to limit the present invention, and other methods may be used. The DWA is widely applied in that constraints such as kinematics and an acceleration can be considered. The moving object 100 according to the present embodiment is the differential two-wheel mobility vehicle with the tail wheel, and is classified as a relatively large vehicle among small mobility vehicles since it is assumed that a person rides on the vehicle. Therefore, an angle of the tail wheel 121 greatly affects the motion of the mobility vehicle, and a target trajectory and an actual trajectory are different from each other with the DWA according to a conventional differential two-wheel model, which is dangerous. Thus, the DWA is extended in the present embodiment to introduce a constraint on the tail wheel angle.

Although the tail wheel 121 is the driven wheel, a reaction force from the ground caused by the tail wheel increases in a case where the angle of the tail wheel 121 is greatly different from the advancing direction of the moving object 100, and the reaction force rapidly decreases when an orientation of the tail wheel returns to the advancing direction. At this time, an angular velocity in the yaw direction depending on the orientation of the tail wheel 121 is generated, and a movement of the vehicle is greatly disturbed, and is sometimes greatly separated from a trajectory predicted by the DWA. In order to prevent a collision caused by the above, the constraint associated with the tail wheel angle is introduced in addition to the conventional DWA constraints. First, the tail wheel angle of the differential two-wheel mobility vehicle is estimated as in the following Formula (2).

δ=−arctan(Lω/v) Formula (2)

Here, δ represents the angle of the tail wheel 121 (tail wheel angle), v represents a speed of the moving object 100, ω represents the angular velocity, and L represents a wheelbase.

The DWA is an algorithm for determining an optimal combination of a speed and an acceleration from a window of a speed and an angular velocity in consideration of a speed constraint, an acceleration constraint, and a collision constraint. In addition, the constraint based on the tail wheel angle is introduced in the present embodiment. When the tail wheel angle is different from the advancing direction, the reaction force of the tail wheel is received if the speed is high, and thus, the speed and the angular velocity are limited in accordance with the tail wheel angle. For example, the restriction window (a maximum value and a minimum value of the speed and a maximum value and a minimum value of the angular velocity) of the speed and the angular velocity is provided such that the vehicle travels at a low speed until the tail wheel angle returns to the same direction as the advancing direction, and the vehicle can travel at a maximum speed after the tail wheel 121 follows the advancing direction. As a result, it is possible to prevent the disturbance of the movement of the vehicle due to a rapid change in the tail wheel angle, and enables continuous movement.

<Basic Control of Moving Object>

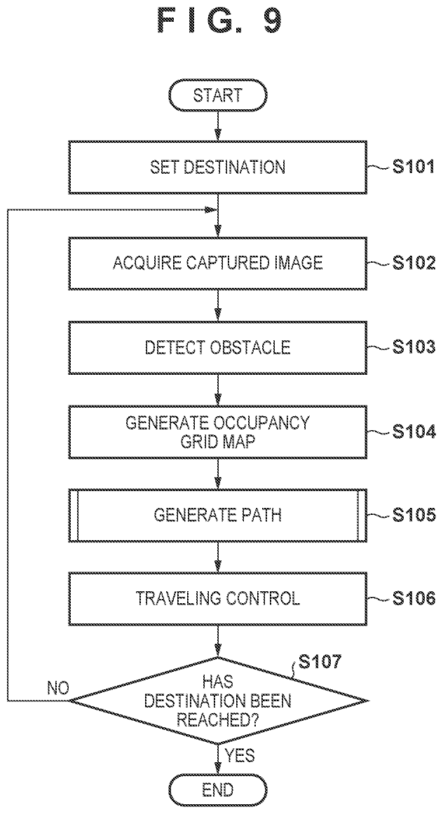

FIG. 9 is a flowchart illustrating basic control of the moving object 100 according to the present embodiment. Processing to be described below is achieved as, for example, the CPU in the control unit 130 reads a program stored in a memory such as a ROM into a RAM and executes the program.

In S101, the control unit 130 sets a target position of the moving object 100 based on a user instruction received by the user instruction acquisition unit 301. The user instruction can be received by various methods as described above. Subsequently, in S102, the control unit 130 captures an image of a front region of the moving object 100 by the detection unit 114, and acquires the captured image. The acquired captured image is processed by the image information processing unit 302, and a depth image is created and formed into a three-dimensional point cloud. In S103, the control unit 130 detects an obstacle that is a three-dimensional object of, for example, 5 cm or more from the image formed into the three-dimensional point cloud. In S104, the control unit 130 generates an occupancy grid map of a predetermined region around the moving object 100 based on position information of the detected obstacle and the moving object 100.

Next, in S105, the control unit 130 causes the path generation unit 304 to generate a travel path of the moving object 100. As described above, the path generation unit 304 generates a global path using the occupancy grid map and the above-described first cost to third cost, and generates a local path according to the generated global path. Subsequently, in S106, the control unit 130 determines a speed and an angular velocity of the moving object 100 according to the generated local path, and controls traveling. Thereafter, in S107, the control unit 130 determines whether or not the moving object 100 has reached the target position based on position information from the GNSS sensor 134, and when the moving object 100 has not reached the target position, returns the processing to S102 to repeatedly perform the process of generating a path and controlling traveling while updating the occupancy grid map. On the other hand, the processing of the flowchart is ended when the moving object 100 has reached the target position.

<Path Generation Control>

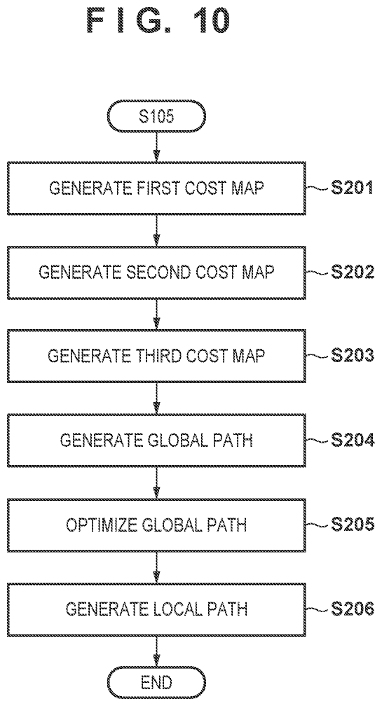

FIG. 10 is a flowchart illustrating a detailed processing procedure of path generation control (S105) according to the present embodiment. Processing to be described below is achieved as, for example, the CPU in the control unit 130 reads a program stored in a memory such as a ROM into a RAM and executes the program.

In S201, the control unit 130 generates a first cost map that defines, for each grid, the first cost that is higher as a distance from a current position of the moving object 100 is longer. Subsequently, in S202, the control unit 130 generates a second cost map that defines, for each grid, the second cost that is higher as a distance from the target position is longer. Further, in S203, the control unit 130 generates a third cost map that defines, for each grid, the third cost that is higher as a distance from a past path is longer.

Subsequently, in S204, the control unit 130 generates a global path according to the improved A* algorithm using the first to third cost maps generated in S201 to S203 and information of the occupancy grid map generated in S104. Subsequently, in S205, the control unit 130 optimizes the generated global path by the above-described Theta* algorithm to generate an optimized global path. Thereafter, the control unit 130 generates a local path in S206 so as to follow the global path optimized in S205, and ends the processing of the flowchart. Note that the flow of generating the local path after generating the global path has been described, but the respective paths are not necessarily generated in this order. This is because a generation cycle of the global path is different from a generation cycle of the local path. For example, in a case where the generation cycle of the global path is 100 ms and the generation cycle of the local region is 50 ms, the local path generation is performed twice according to a generated global path.

<Summary of Embodiment>

1. A moving object control system (100) in the above embodiment, comprising:
an acquisition unit (114) configured to acquire a captured image;
a detection unit (130, 302, 303) configured to detect an obstacle included in the captured image;
a map generation unit (303) configured to divide a region around a moving object and generate an occupancy map indicating occupancy of the obstacle detected by the detection unit for each of divided regions; and
a path generation unit (304, S201-S204, FIG. 7) configured to generate a global path from a current position to a target position for avoiding the detected obstacle based on a first cost, a second cost, and a third cost, the first cost being higher as a distance from the current position is longer on the occupancy map, the second cost being higher as a distance from the target position is longer on the occupancy map, and the third cost being higher as a distance from a past path is longer on the occupancy map.

According to the present embodiment, in order to preferentially search for a grid for which path planning was performed in the past in real-time path planning on an occupancy map, a pseudo potential map is generated such that a place where a path was present becomes lower, and is used for an evaluation function. Thus, a path of a moving object can be suitably generated without using a high-precision map according to the present invention.

2. In the above embodiment, the path generation unit further optimizes the generated global path using a Theta* algorithm that searches for a parent node having a minimum distance.

According to the present embodiment, a linear path can be generated without depending on a node on a grid map.

3. In the above embodiment, the third cost is generated using a Gaussian filter or an averaging filter.

According to the present embodiment, a cost based on a past path can be easily created.

4. In the above embodiment, the path generation unit acquires the third cost using the filter along the past path.

According to the present embodiment, the past path can be used more efficiently.

5. In the above embodiment, the past path is a path previously generated by the path generation unit.

According to the present embodiment, a search range can be further reduced by following an immediately preceding path.

6. In the above embodiment, the first cost is further determined based on the obstacle detected by the detection unit.

According to the present embodiment, it is possible to avoid generation of a path passing through a final edge of the obstacle.

7. In the above embodiment,
the acquisition unit acquires a captured image of a front region of the moving object, and
the map generation unit generates the occupancy map for an obstacle in a region not acquired by the acquisition unit using information on an obstacle detected in past by the detection unit.

According to the present embodiment, even in a case where the moving object turns and regains, information on obstacles detected in the past can be used, and it is possible to avoid collisions with the obstacles or a stack in a dead end.

8. In the above embodiment, the path generation unit further generates a local path of the moving object based on a dynamic window approach (DWA) to follow the global path.

According to the present embodiment, it is possible to perform traveling control considering an orientation of a driven wheel.

9. In the above embodiment, the moving object control system further comprises a traveling control unit configured to determine a speed and an angular velocity of the moving object based on the local path and control traveling.

According to the present embodiment, it is possible to perform the traveling control in consideration of the orientation of the driven wheel.

10. In the above embodiment, the path generation unit generates the global path and the local path at different cycles.

According to the present embodiment, unnecessary path generation can be reduced, and a processing load can be reduced.

11. In the above embodiment, a generation cycle of the local path is shorter than a generation cycle of the global path.

According to the present embodiment, unnecessary path generation can be reduced, and a processing load can be reduced.

12. In the above embodiment,
the acquisition unit is a stereo camera, and
the detection unit converts image data of a stereo image captured by the stereo camera into a three-dimensional point cloud.

According to the present embodiment, a processing amount can be reduced, and real-time processing can be suitably realized.

13. In the above embodiment, the map generation unit divides a region around the moving object into grids, and generates an occupancy grid map indicating occupancy of an obstacle detected by the detection unit for each of the grids as the occupancy map.

According to the present embodiment, a predetermined planar region can be easily divided in x and y directions, and a predetermined range can be covered without omission.

14. A moving object (100) in the above embodiment, comprising:
an acquisition unit (114) configured to acquire a captured image;
a detection unit (130, 302, 303) configured to detect an obstacle included in the captured image;
a map generation unit (303) configured to divide a region around the moving object and generate an occupancy map indicating occupancy of the obstacle detected by the detection unit for each of divided regions; and
a path generation unit (304, S201-S204, FIG. 7) configured to generate a global path from a current position to a target position for avoiding the detected obstacle based on a first cost, a second cost, and a third cost, the first cost being higher as a distance from the current position is longer on the occupancy map, the second cost being higher as a distance from the target position is longer on the occupancy map, and the third cost being higher as a distance from a past path is longer on the occupancy map.

According to the present embodiment, in order to preferentially search for a grid for which path planning was performed in the past in real-time path planning on an occupancy map, a pseudo potential map is generated such that a place where a path was present becomes lower, and is used for an evaluation function. Thus, a path of a moving object can be suitably generated without using a high-precision map according to the present invention.

According to the present invention, it is possible to suitably generate the path of the moving object without using the high-precision map and to reduce the processing amount.

The invention is not limited to the foregoing embodiments, and various variations/changes are possible within the spirit of the invention.

What is claimed is:

1. A moving object control system comprising:
an acquisition unit configured to acquire a captured image;
a detection unit configured to detect an obstacle included in the captured image;
a map generation unit configured to divide a region around a moving object and generate an occupancy map indicating occupancy of the obstacle detected by the detection unit for each of divided regions; and
a path generation unit configured to generate a global path from a current position to a target position for avoiding the detected obstacle based on a first cost, a second cost, and a third cost, the first cost being higher as a distance from the current position is longer on the occupancy map, the second cost being higher as a distance from the target position is longer on the occupancy map, and the third cost being higher as a distance from a past path is longer on the occupancy map.

2. The moving object control system according to claim 1, wherein the path generation unit further optimizes the generated global path using a Theta* algorithm that searches for a parent node having a minimum distance.

3. The moving object control system according to claim 1, wherein the third cost is generated using a Gaussian filter or an averaging filter.

4. The moving object control system according to claim 3, wherein the path generation unit acquires the third cost using the filter along the past path.

5. The moving object control system according to claim 4, wherein the past path is a path previously generated by the path generation unit.

6. The moving object control system according to claim 2, wherein the first cost is further determined based on the obstacle detected by the detection unit.

7. The moving object control system according to claim 2, wherein
the acquisition unit acquires a captured image of a front region of the moving object, and
the map generation unit generates the occupancy map for an obstacle in a region not acquired by the acquisition unit using information on an obstacle detected in past by the detection unit.

8. The moving object control system according to claim 7, wherein the path generation unit further generates a local path of the moving object based on a dynamic window approach (DWA) to follow the global path.

9. The moving object control system according to claim 8, further comprising a traveling control unit configured to determine a speed and an angular velocity of the moving object based on the local path and control traveling.

10. The moving object control system according to claim 8, wherein the path generation unit generates the global path and the local path at different cycles.

11. The moving object control system according to claim 10, wherein a generation cycle of the local path is shorter than a generation cycle of the global path.

12. The moving object control system according to claim 1, wherein
the acquisition unit is a stereo camera, and
the detection unit converts image data of a stereo image captured by the stereo camera into a three-dimensional point cloud.

13. The moving object control system according to claim 2, wherein the map generation unit divides a region around the moving object into grids, and generates an occupancy grid map indicating occupancy of an obstacle detected by the detection unit for each of the grids as the occupancy map.

14. A moving object comprising:
an acquisition unit configured to acquire a captured image;
a detection unit configured to detect an obstacle included in the captured image;
a map generation unit configured to divide a region around the moving object and generate an occupancy map indicating occupancy of the obstacle detected by the detection unit for each of divided regions; and
a path generation unit configured to generate a global path from a current position to a target position for avoiding the detected obstacle based on a first cost, a second cost, and a third cost, the first cost being higher as a distance from the current position is longer on the occupancy map, the second cost being higher as a distance from the target position is longer on the occupancy map, and the third cost being higher as a distance from a past path is longer on the occupancy map.

15. A control method of a moving object control system, the control method comprising:
acquiring a captured image;
detecting an obstacle included in the captured image;
dividing a region around a moving object and generating an occupancy map indicating occupancy of the obstacle detected for each of divided regions; and
generating a global path from a current position to a target position for avoiding the detected obstacle based on a first cost, a second cost, and a third cost, the first cost being higher as a distance from the current position is longer on the occupancy map, the second cost being higher as a distance from the target position is longer on the occupancy map, and the third cost being higher as a distance from a past path is longer on the occupancy map.

16. A non-transitory storage medium storing a program that causes a computer to function as:
an acquisition unit configured to acquire a captured image;
a detection unit configured to detect an obstacle included in the captured image;
a map generation unit configured to divide a region around a moving object and generate an occupancy map indicating occupancy of the obstacle detected by the detection unit for each of divided regions; and
a path generation unit configured to generate a global path from a current position to a target position for avoiding the detected obstacle based on a first cost, a second cost, and a third cost, the first cost being higher as a distance from the current position is longer on the occupancy map, the second cost being higher as a distance from the target position is longer on the occupancy map, and the third cost being higher as a distance from a past path is longer on the occupancy map.
